(19) United States
(12) Patent Application Publication
(10) Pub. No.: US 2020/0393908 A1
(43) Pub. Date: Dec. 17, 2020

(54) COMPUTING DEVICES, PROGRAM PRODUCTS, AND METHODS FOR PERFORMING ACTIONS IN APPLICATIONS BASED ON FACIAL IMAGES OF USERS

(71) Applicant: CITRIX SYSTEMS, INC., Fort Lauderdale, FL (US)

(72) Inventor: Shikha Kejariwal, Pompano Beach, FL (US)

(21) Appl. No.: 16/438,989

(22) Filed: Jun. 12, 2019

(51) Int. Cl. G06F 3/01; G06K 9/00

(52) U.S. Cl. CPC G06F 3/017; G06K 9/00335; G06K 9/00268; G06F 3/012

(57) ABSTRACT

Computing devices, program products, and methods for performing actions in applications of computing devices are disclosed. One method includes continuously monitoring a facial gesture of a user, via a camera in communication with the computing device, in response to the user engaging the application on the computing device and comparing the monitored facial gesture of the user with a plurality of predetermined facial gestures. Each of the plurality of predetermined facial gestures are associated with a corresponding action performed in the application of the computing device. The method also includes executing the corresponding action associated with the matched, predetermined facial gesture in the application in response to determining the monitored facial gesture of the user matches a predetermined facial gesture of the plurality of predetermined facial gestures.

### BACKGROUND OF THE INVENTION

The disclosure relates generally to performing actions in an application operating on a computing device, and more particularly, to performing actions in the application based solely on analyzing facial images of a user of the computing device.

Computing devices including mobile devices (e.g., smartphones and tablets) and computers (e.g., desktops and laptops) require users to physically interact with and/or touch input devices (e.g., touch screens, mouse, keyboard) in order operate or engage applications or programs included thereon. The physical interaction and/or touching of these input devices is required even for performing fundamental tasks or functions, for example scrolling through a word document. Additionally, performing fundamental tasks often includes multiple, physical interactions and/or movements. For example, a user deleting more than one e-mail often has to select each individual e-mail, click or touch a delete button, and confirm that they wish to delete all the selected e-mails. These physical and/or touch requirements can be cumbersome for a user trying to multitask while using the computing device. This often slows down the user's productivity and/or frustrates the user. Alternatively, physically interacting and/or touching the computing device to interact and/or engage the application can be impossible for individuals who suffer from disabilities. As such, these individuals do not have the ability to even engage with the computing device and/or certain applications included on the computing device.

### BRIEF DESCRIPTION OF THE INVENTION

A first aspect of the disclosure provides a method of performing actions in an application of a computing device. The method includes: continuously monitoring a facial gesture of a user, via a camera in communication with the computing device, in response to the user engaging the application on the computing device; comparing the monitored facial gesture of the user with a plurality of predetermined facial gestures, each of the plurality of predetermined facial gestures are associated with a corresponding action performed in the application of the computing device; and in response to determining the monitored facial gesture of the user matches a predetermined facial gesture of the plurality of predetermined facial gestures, executing the corresponding action associated with the matched, predetermined facial gesture in the application.

A second aspect of the disclosure provides a computing device including: a camera; at least one processor; and memory storing computer-executable instructions that, when executed by the at least one processor, cause the computing device to: capture a first facial image of a user, using the camera, in response to the user engaging the application on the computing device, the first facial image including a baseline facial gesture for a plurality of facial features for the user; detect movement of at least one facial feature of the plurality of facial features of the user engaging the application on the computing device; determine if the detected movement of the at least one facial feature of the plurality of facial features of the user exceeds a facial gesture threshold, the facial gesture threshold based on a predetermined deviation of the at least one facial feature from the baseline facial gesture for the user; in response to determining the detected movement of the at least one facial feature of the plurality of facial features of the user exceeds the facial gesture threshold, identify an action performed in the application of the computing device that is associated with the detected movement of the at least one facial feature exceeding the facial gesture threshold; and execute the action associated with the detected movement of the at least one facial feature exceeding the facial gesture threshold.

A third aspect of the disclosure provides a computer program product stored on a non-transitory computer readable storage medium, which when executed by a computing device including a camera, performs actions in an application of the computing device. The computer program product includes: program code that instructs the camera to capture a first facial image of a user in response to the user engaging the application on the computing device, the first facial image including a baseline facial gesture for a plurality of facial features for the user; program code that instructs the camera to detect movement of at least one facial feature of the plurality of facial features of the user engaging the application on the computing device; program code that determines if the detected movement of the at least one facial feature of the plurality of facial features of the user exceeds a facial gesture threshold, the facial gesture threshold based on a predetermined deviation of the at least one facial feature from the baseline facial gesture for the user; program code that identifies an action performed in the application of the computing device that is associated with the detected movement of the at least one facial feature exceeding the facial gesture threshold in response to determining the detected movement of the at least one facial feature of the plurality of facial features of the user exceeds the facial gesture threshold; and program code that executes the action associated with the detected movement of the at least one facial feature exceeding the facial gesture threshold.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows a block diagram of a network environment, in accordance with an illustrative embodiment.

FIG. 2 shows a block diagram of a computing device, in accordance with an illustrative embodiment.

FIG. 3 shows a front view of the computing device including a camera, in accordance with an illustrative embodiment.

FIG. 4 shows a front view of the computing device of FIG. 3 including an e-mail application, in accordance with an illustrative embodiment.

FIG. 5A shows a facial image of a user captured by the camera of the computing device of FIGS. 3 and 4, in accordance with an illustrative embodiment.

FIG. 5B shows a front view of the computing device including the e-mail application, in accordance with an illustrative embodiment.

FIG. 6A shows a facial image of a user captured by the camera of the computing device, in accordance with an illustrative embodiment.

FIG. 6B shows a generated facial image included a predetermined facial gesture, in accordance with an illustrative embodiment.

FIG. 6C shows a front view of the computing device performing an action within the e-mail application, in accordance with an illustrative embodiment.

FIGS. 7A-15A show various facial images of a user captured by the camera of the computing device, FIGS. 7B-15B show various generated facial images included a predetermined facial gesture, and FIGS. 7C-15C show various front views of the computing device performing actions within the e-mail application, in accordance with an illustrative embodiment.

FIG. 16 shows flow diagram for performing an action within an application of a computing device, in accordance with an illustrative embodiment.

FIG. 17 shows flow diagram for performing an action within an application of a computing device, in accordance with another illustrative embodiment.

It is noted that the drawings of the disclosure are not to scale. The drawings are intended to depict only typical aspects of the disclosure, and therefore should not be considered as limiting the scope of the disclosure. In the drawings, like numbering represents like elements between the drawings.

### DETAILED DESCRIPTION OF THE INVENTION

As an initial matter, in order to clearly describe the current disclosure it will become necessary to select certain terminology when referring to and describing relevant machine components within the disclosure. When doing this, if possible, common industry terminology will be used and employed in a manner consistent with its accepted meaning. Unless otherwise stated, such terminology should be given a broad interpretation consistent with the context of the present application and the scope of the appended claims. Those of ordinary skill in the art will appreciate that often a particular component may be referred to using several different or overlapping terms. What may be described herein as being a single part may include and be referenced in another context as consisting of multiple components. Alternatively, what may be described herein as including multiple components may be referred to elsewhere as a single part.

Embodiments of the disclosure provide computing devices, program products and methods performing actions in the application based solely on analyzing facial images (e.g., facial gestures) of a user of the computing device. Performing actions in the application based solely on facial images and/or facial gestures, as discussed herein, allows a user to interact with the application without having to physically touch or interact with the computing device. The benefit of being able to interaction with the application (e.g., execute actions therein) improves the user's experience with the application of the computing device by providing the opportunity to interact with the application on the computing device and perform another task with the user's hands. Additionally, performing actions in applications based on facial gestures allows user's with disabilities (e.g., paralysis) the ability to engage and interact with applications on computing devices that otherwise required physical interaction and/or engagement. One method includes, for example, continuously monitoring facial gestures of a user and comparing the monitored facial gestures to a plurality of predetermined facial gestures. In response to the monitored facial gesture matching a predetermined facial gesture, an action associated with the matched, predetermined facial gesture is executed in the application. Another method includes, defining a baseline facial gesture for a plurality of facial features of a user, and detecting movement of at least one facial feature of the user. In response to detecting the movement, it is determined if the movement exceeds a facial gesture threshold based on a predetermined deviation of the facial feature from the defined, baseline facial gesture. If the movement exceeds the facial gesture threshold, then an action associated with the detected movement of the facial feature is identified and executed within the application.

For purposes of reading the description of the various embodiments below, the following descriptions of the sections of the specification and their respective contents may be helpful:

Section A describes a network environment and computing environment which may be useful for practicing embodiments described herein;

Section B describes a computing device including a plurality of interactive applications; and

Section C describes embodiments of methods for performing actions within applications of a computing device using facial gestures.

A. Network and Computing Environment

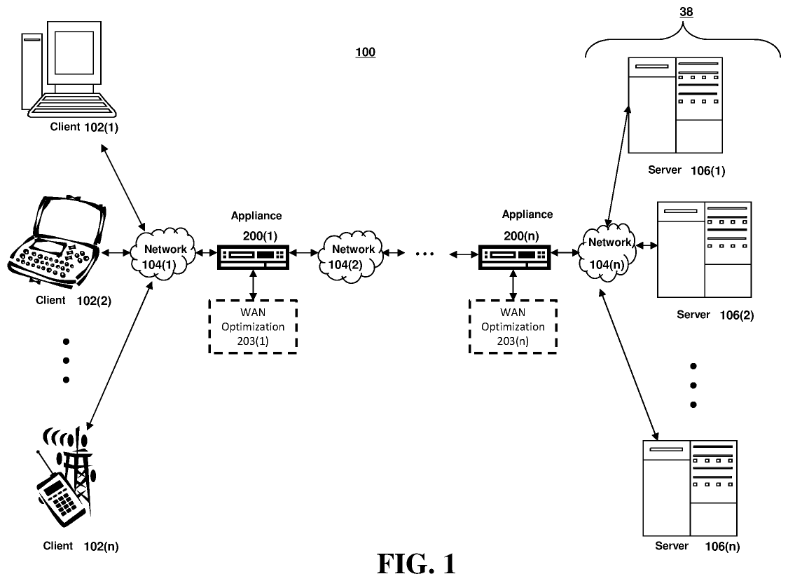

Referring to FIG. 1, an illustrative network environment 100 is depicted. Network environment 100 may include one or more clients 102(1)-102(n) (also generally referred to as local machine(s) 102 or client(s) 102) in communication with one or more servers 106(1)-106(n) (also generally referred to as remote machine(s) 106 or server(s) 106) via one or more networks 104(1)-104n (generally referred to as network(s) 104). In some embodiments, a client 102 may communicate with a server 106 via one or more appliances 200(1)-200n (generally referred to as appliance(s) 200 or gateway(s) 200).

Although the embodiment shown in FIG. 1 shows one or more networks 104 between clients 102 and servers 106, in other embodiments, clients 102 and servers 106 may be on the same network 104. The various networks 104 may be the same type of network or different types of networks. For example, in some embodiments, network 104(1) may be a private network such as a local area network (LAN) or a company Intranet, while network 104(2) and/or network 104(n) may be a public network, such as a wide area network (WAN) or the Internet. In other embodiments, both network 104(1) and network 104(n) may be private networks. Networks 104 may employ one or more types of physical networks and/or network topologies, such as wired and/or wireless networks, and may employ one or more communication transport protocols, such as transmission control protocol (TCP), internet protocol (IP), user datagram protocol (UDP) or other similar protocols.

As shown in FIG. 1, one or more appliances 200 may be located at various points or in various communication paths of network environment 100. For example, appliance 200 may be deployed between two networks 104(1) and 104(2), and appliances 200 may communicate with one another to work in conjunction to, for example, accelerate network traffic between clients 102 and servers 106. In other embodiments, the appliance 200 may be located on a network 104. For example, appliance 200 may be implemented as part of one of clients 102 and/or servers 106. In an embodiment, appliance 200 may be implemented as a network device such as Citrix Networking products sold by Citrix Systems, Inc. of Fort Lauderdale, Fla.

As shown in FIG. 1, one or more servers 106 may operate as a server farm 38. Servers 106 of server farm 38 may be logically grouped, and may either be geographically co-located (e.g., on premises) or geographically dispersed (e.g., cloud based) from clients 102 and/or other servers 106. In an embodiment, server farm 38 executes one or more applications on behalf of one or more of clients 102 (e.g., as an application server), although other uses are possible, such as a file server, gateway server, proxy server, or other similar server uses. Clients 102 may seek access to hosted applications on servers 106.

As shown in FIG. 1, in some embodiments, appliances 200 may include, be replaced by, or be in communication with, one or more additional appliances, such as WAN optimization appliances 205(1)-205(n), referred to generally as WAN optimization appliance(s) 205. For example, WAN optimization appliance 205 may accelerate, cache, compress or otherwise optimize or improve performance, operation, flow control, or quality of service of network traffic, such as traffic to and/or from a WAN connection, such as optimizing Wide Area File Services (WAFS), accelerating Server Message Block (SMB) or Common Internet File System (CIFS). In some embodiments, appliance 205 may be a performance enhancing proxy or a WAN optimization controller. In one embodiment, appliance 205 may be implemented as Citrix SD-WAN products sold by Citrix Systems, Inc. of Fort Lauderdale, Fla.

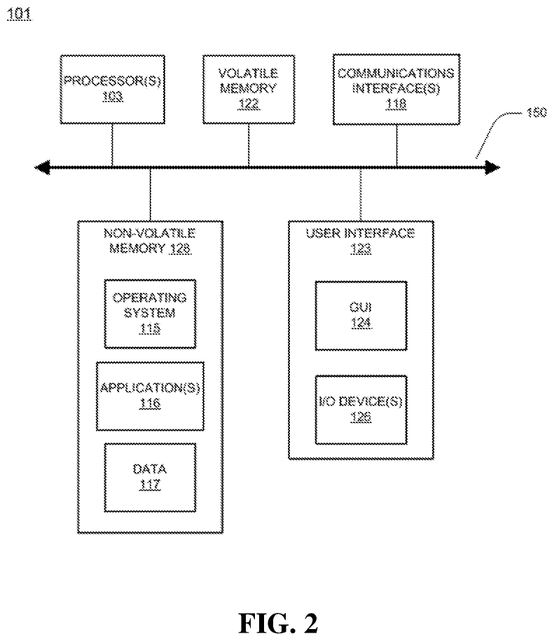

In described embodiments, clients 102, servers 106, and appliances 200 and 205 may be deployed as and/or executed on any type and form of computing device, such as any desktop computer, laptop computer, or mobile device capable of communication over at least one network and performing the operations described herein. For example, clients 102, servers 106 and/or appliances 200 and 205 may each correspond to one computer, a plurality of computers, or a network of distributed computers such as computer or computing device 101 shown in FIG. 2.

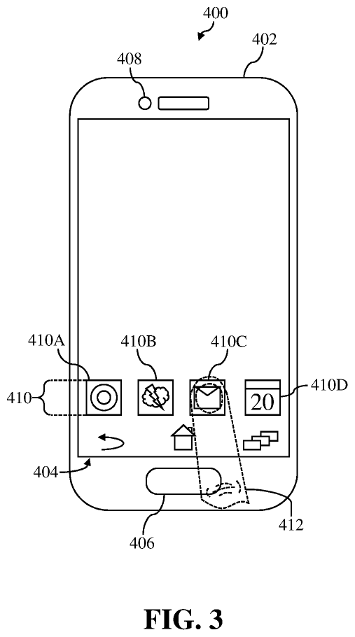

As shown in FIG. 2, computing device 101 may include one or more processors 103, volatile memory 122 (e.g., RAM), non-volatile memory 128 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 123, one or more communications interfaces 118, and communication bus 150. User interface 123 may include graphical user interface (GUI) 124 (e.g., a touchscreen, a display, etc.) and one or more input/output (I/O) devices 126 (e.g., a mouse, a keyboard, a camera (see, FIG. 3), etc.). Non-volatile memory 128 stores operating system 115, one or more applications 116, and data 117 such that, for example, computer instructions of operating system 115 and/or applications 116 are executed by processor(s) 103 out of volatile memory 122. Applications 116 can include, but are not limited to, Citrix Workspace sold by Citrix Systems, Inc. of Fort Lauderdale, Fla. Data may be entered using an input device of GUI 124 or received from I/O device(s) 126. Various elements of computing device 101 may communicate via communication bus 150. Computing device 101 as shown in FIG. 2 is shown merely as an example, as clients 102, servers 106 and/or appliances 200 and 205 may be implemented by any computing or processing environment and with any type of machine or set of machines that may have suitable hardware and/or software capable of operating as described herein.

Processor(s) 103 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

Communications interfaces 118 may include one or more interfaces to enable computing device 101 to access a computer network such as a LAN, a WAN, or the Internet through a variety of wired and/or wireless or cellular connections.

In described embodiments, a first computing device 101 may execute an application on behalf of a user of a client computing device (e.g., a client 102), may execute a virtual machine, which provides an execution session within which applications execute on behalf of a user or a client computing device (e.g., a client 102), such as a hosted desktop session, may execute a terminal services session to provide a hosted desktop environment, or may provide access to a computing environment including one or more of: one or more applications, one or more desktop applications, and one or more desktop sessions in which one or more applications may execute.

B. Computing Device including Interactive Applications

FIG. 3 shows an illustrative front view of a computing device 400, according to embodiments. Computing device 400 shown in FIG.3 includes and/or is similar to, for example, computing device 101 discussed herein with respect to FIG. 2. As discussed in detail herein, computing device 400, and its processing/computing device(s) and/or component(s) included therein, are configured to allow a user of computing device 400 to perform or execute actions within an application on computing device 400 based solely on facial imaging and/or facial gestures. Providing the user, the ability to perform actions within an application of computing device 400 without having to touch or physically interact with computing device 400 may allow the user to perform actions on the computing device 400 while also perform additional tasks on another matter or project (e.g., multitasking). Additionally, computing device 400 as discussed herein may allow user to perform actions using facial images and/or facial gestures that would otherwise require multiple touches and/or interactions to perform. As such, providing the user the ability to perform actions without having to touch or physically interact with computing device 400 may reduce the time in performing certain actions in the application. Finally, users who lack the ability to physically touch and/or interact with computing device 400 may use the applications of computing device 400 to their full extent and/or perform actions within the applications of computing device 400 using only facial imagery and/or facial gestures.

In the non-limiting example shown in FIG. 3, computing device 400 is implemented as a smart telephone. In other non-limiting examples, computing device 400 can be implemented as any suitable device including, but not limited, a laptop or desktop computer, a tablet computing device, a gaming device, a display, a digital music player, a wearable computing device or display such as a watch, and other suitable type of computing device that include a touch display, at least one camera, and icons associated with interactive applications, commonly known as “Apps,” and/or documents (e.g., word-processing documents) of computing device 400.

Computing device 400 includes a casing 402 at least partially surrounding a touch display 404 and one or more buttons 406, as shown in FIG. 3. Casing 402 can form an outer surface or partial outer surface and protective case for the internal components of computing device 400, and at least partially surrounds touch display 404. Casing 402 can be formed of one or more components operably connected together, such as a front piece and a back piece. Alternatively, casing 402 can be formed of a single piece operably connected to the touch display 404.

Touch display 404 can be implemented with any suitable technology, including, but not limited to, a multi-touch sensing touchscreen that uses liquid crystal display (LCD) technology, light emitting diode (LED) technology, organic light-emitting display (OLED) technology, organic electroluminescence (OEL) technology, or another type of display technology. As discussed herein, button 406 is utilized by computing device 400 to provide user input and/or allow the user to interact with the various functions of computing device 400.

As shown in FIG. 3, computing device 400 also includes at least one camera 408. Specifically, and in the non-limiting example shown in FIG. 3, camera 408 is positioned on a front side of computing device 100. A second distinct camera (not shown) can also be position on a back side of computing device 400. As discussed herein, camera 408 can display a viewed, real-time and/or captured image on touch display 404 of computing device 400. Camera 408 is any suitable camera component, device and/or system that may be configured to capture images and/or videos on computing device 400. It is understood that computing device 400 may include more or less cameras 408 than the number of cameras 408 depicted in and/or discussed herein with respect to FIG. 3.

Computing device 400 also includes a plurality of icons 410A-410D (collectively, “icons 410”). Specifically, touch display 404 provides, displays, and/or visually depicts a plurality of icons 410, where each icon of the plurality of icons 410 is associated with an application (commonly referred to as “App”) and/or a document included within computing device 400. The applications associated with the plurality of icons 410 are stored within any suitable memory or storage device (internal, external, cloud-based and so on) on and/or associated with computing device 400 and may be configured to be interacted with by a user of computing device 400 for providing communication capabilities and/or information to the user. Additionally, as discussed herein, the applications are interacted with, opened, and/or accessed when a user of computing device 400 engages, activates and/or interacts (e.g., taps or clicks) with the icon 410 associated with a specific application. The applications associated with the plurality of icons 410 may include messaging applications (e.g., Short Message Service (SMS), Multimedia Messaging Services (MMS), electronic mail (e-mail) and so on), communication applications (e.g., telephone, video-conferencing, and so on), multimedia applications (e.g., cameras, picture libraries, music libraries, video libraries, games and so on), information applications (e.g., global positioning systems (GPS), weather, internet, news and so on), and any other suitable applications that may be included within computing device 400. In the non-limiting example shown in FIG. 3, computing device 400 includes icon 410A associated with a camera application that interacts and/or controls cameras 408 of computing device 400, icon 410B associated with a weather application, icon 410C associated with an e-mail application and icon 410D associated with a calendar or planner application.

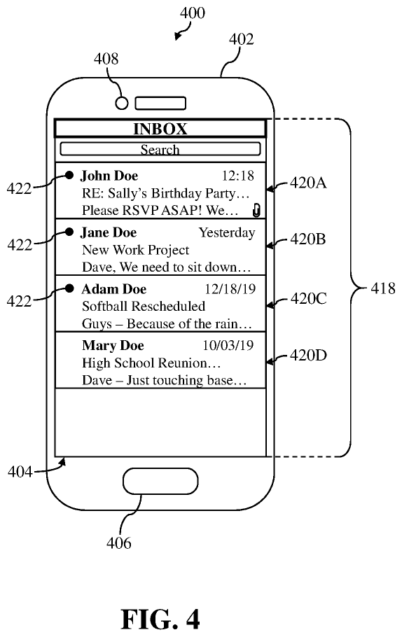

A user 412, and specifically a user's finger (shown in phantom), is shown to be interacting with computing device 400 to engage and/or open an application associated with one of the plurality of icons 410 shown on touch display 404. Specifically, user 412 interacts with computing device 400 by making an initial touch or contact with touch display 404. The initial touch performed on touch display 404 by user 412 and/or user's finger may engage the application. In the non-limiting example shown in FIG. 3, user 412 touches and/or contacts icon 410C to engage and/or open the e-mail application associated with icon 410C. In another non-limiting example, user 412 can open and/or engage the e-mail application of computing device 400, and associated with icon 410C, by verbally instructing computing device 400 to open the e-mail application using a microphone (not shown) included within computing device 400. As discussed herein, once the e-mail application of computing device 400 is engaged and/or opened, user 412 can interact and/or execute actions to be performed within the e-mail application using only facial gestures detected by camera 408 of computing device 400.FIG. 4 shows a front view of computing device 400 after the e-mail application 418 associated with icon 410C is opened and/or engaged by user 412 (see, FIG. 3). The e-mail application 418 is displayed and/or visually represented in touch display 404 of computing device 400. In the non-limiting example, the “INBOX” of e-mail application 418 is shown. The displayed inbox for e-mail application 418 also includes and/or displays, via touch display 404, a plurality of e-mail messages 420A-420D. E-mail messages 420A-420D included in e-mail application 418 are sent to and/or received by the user, owner, and/or e-mail address associated with the e-mail application 418. As shown in FIG. 4, e-mail messages 420A-420D included in e-mail application 418 include a variety of information relating to the e-mail message. For example, e-mail messages 420A-420D include information relating to the sender or sending source of the e-mail (e.g., “John Doe,” “Jane Doe” and so on), the subject of the e-mail message (e.g., “RE: Sally's Birthday Party,” “New Work Project” and so on), time and/or date information relating to when the message was sent/received by the user of e-mail application 418 (e.g., “12:18,” “Yesterday” and so on), and whether or not e-mail messages 420A-420D includes an attachment (e.g., “paperclip” included in e-mail message). Additionally in the non-limiting example, e-mail messages 420A-420D include information and/or indicators that identify a read/unread status of each message. For example, e-mail messages 420A-420C include a symbol or bullet point (hereafter, “symbol 422”) indicating each e-mail message 420A-420C is new and/or unread. Distinct from e-mail messages 420A-420C, e-mail message 420D does not include symbol 422, indicating e-mail message 420D was previously opened and/or read. It is understood that the list of information included in e-mail messages 420A-420D (e.g., sender, subject, received, etc.) is non-limiting, and e-mail messages 420A-420D may include more or less information when displayed in e-mail application 418.

C. Computing Devices and Methods for Performing Actions within Applications of the Computing Devices using Facial Gestures

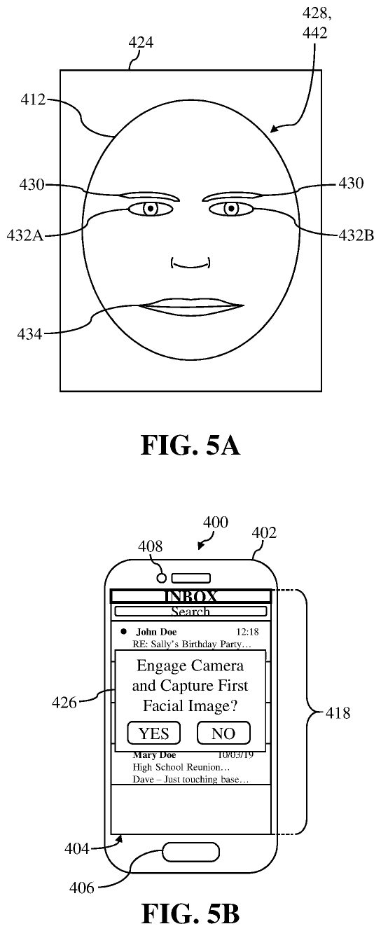

FIGS. 5A-15C depict various non-limiting examples of performing actions in an application of computing device 400. More specifically, FIGS. 5A-15C show various views of facial images of user 412, predetermined facial images and/or gestures associated with executing actions in the application, and computing device 400 performing actions within the application (e.g., e-mail application 418) without requiring user 412 to physically touch computing device 400. It is understood that similarly numbered and/or named components may function in a substantially similar fashion. Redundant explanation of these components has been omitted for clarity.

FIG. 5A shows an initial or first facial image 424 of user 412 obtained by computing device 400. Specifically, FIG. 5A shows a non-limiting example of first facial image 424 of user 412 captured by camera 408 of computing device 400. In a non-limiting example, first facial image 424 may be captured once user 412 engages e-mail application 418 on computing device 400. That is, once e-mail application 418 on computing device 400 is engaged and/or opened by user 412 (e.g., sensed touch, verbal instruction), camera 408 of computing device 400 is automatically engaged and/or operational. As such, camera 408 of computing device 400 automatically captures, obtains, and/or generates first facial image 424 of user 412, as shown in FIG. 5A.

In another non-limiting example, user 412 is prompted to engage camera 408 of computing device 400. More specifically, and as shown in FIG. 5B, user 412 is prompted and/or provided a notification 426 to choose to engage camera 408 of computing device after user 412 engages and/or opens e-mail application 418 on computing device 400. In this non-limiting example, user 412 is provided the option to engage camera 408, and subsequently use facial gestures to execute actions within e-mail application 418, as discussed herein. In response to user 412 affirming (e.g., “YES”) the engagement of camera 408, camera 408 becomes engaged and/or operational and captures and/or obtains first facial image 424 of user 412.

In a non-limiting example, first facial image 424 of user 412 can be a still photograph of the user 412 taken immediately after opening e-mail application 418, or alternatively after user 412 agrees to engage camera 408 after being provided with notification 426. Alternatively, first facial image 424 of user 412 can be a video or live-stream of user's 412 face that is captured or obtained immediately after opening e-mail application 418, or after user 412 agrees to engage camera 408.

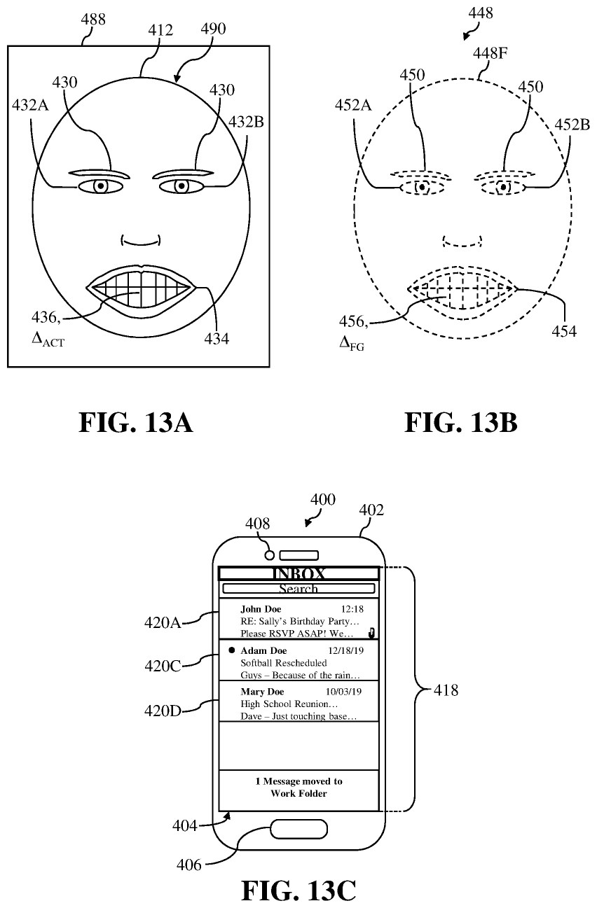

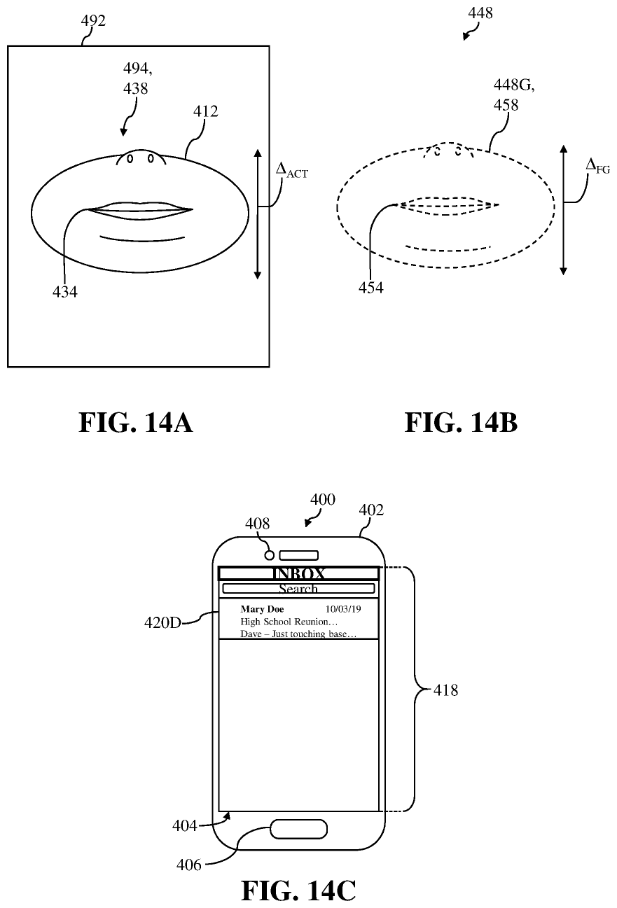

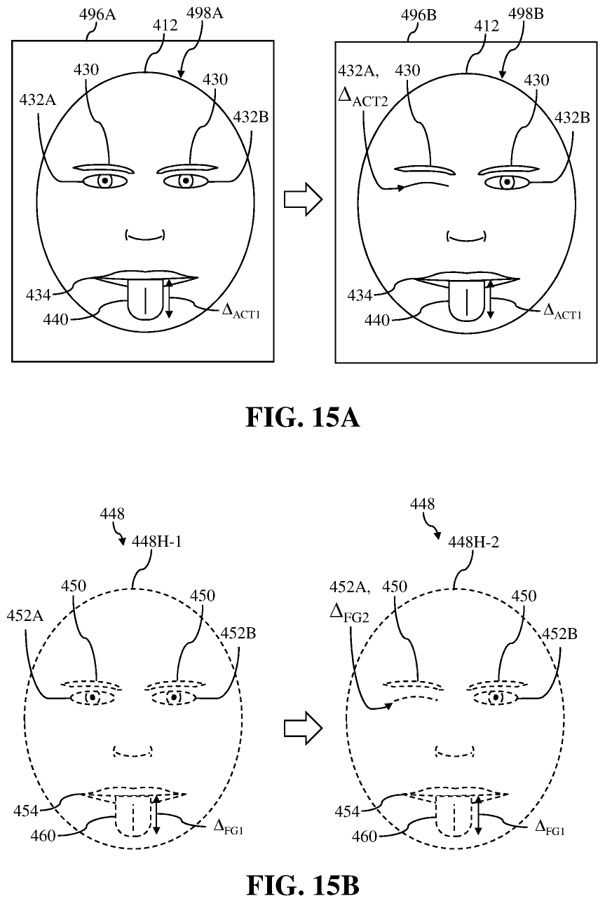

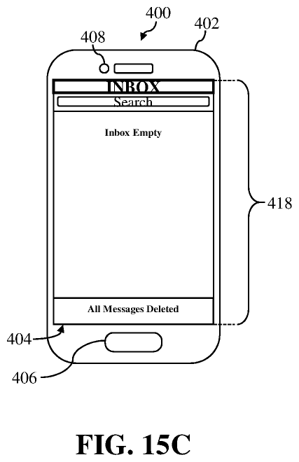

In order to trigger, perform, and/or execute an action to be performed within e-mail application 418 on computing device 400, user 412 is monitored using camera 408 while e-mail application 418 is engaged, opened, and/or operational on computing device 400. In a non-limiting example, user 412 is continuously monitored via camera 408. More specifically, various facial gestures 428 of user 412 are continuously monitored via camera 408 in response to user 412 engaging e-mail application 418 on computing device 400. As used herein, facial gestures 428 may correspond to a position, deviation, and/or movement of at least one facial feature (e.g., eyes, mouth) included in user's 412 face while being monitored by camera 408, and/or engaging and interacting with e-mail application 418 on computing device 400. As such, and in the non-limiting example, continuously monitoring facial gesture 428 of user 412 includes identifying a plurality of facial features 430-440 of user 412 and/or included on user's face. The plurality of facial features of user 412 identified using camera 408 include, but are not limited to, an eyebrow(s) 430 of user 412, an eye 432A, 432B of user 412, a mouth 434 of user 412, a tooth 436 (see, FIG. 13A), a facial position 438 (see, FIG. 14A) of user 412, and/or a tongue 440 of user 412 (See, FIG. 15A). In the non-limiting example shown in FIG. 5A, the facial features included in facial gesture 428 identified in first facial image 424 include user's 412 eyebrows 430, eyes 432A, 432B, and mouth 434.

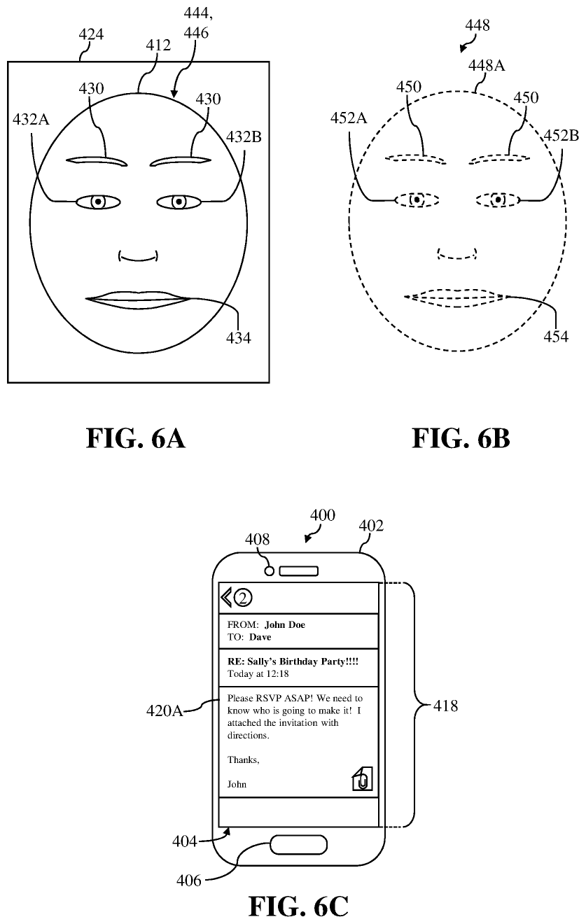

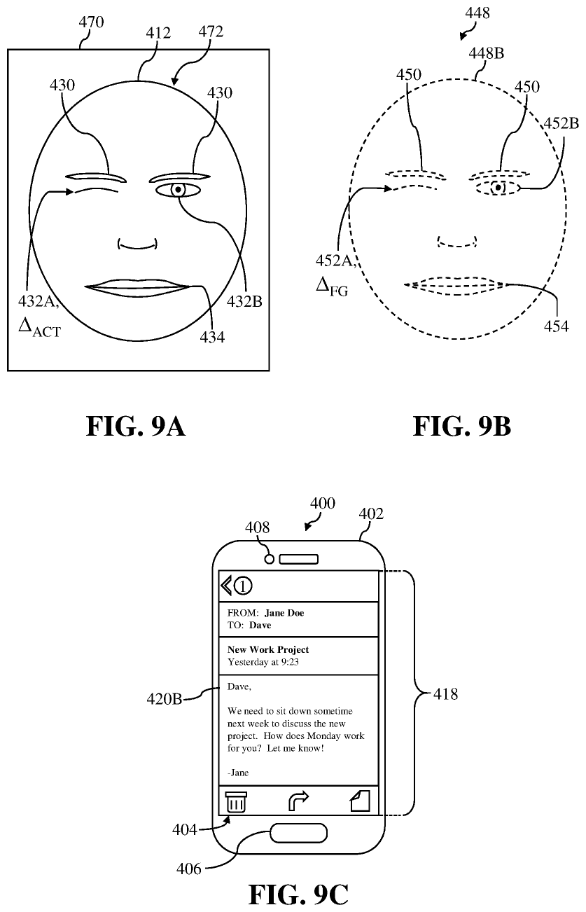

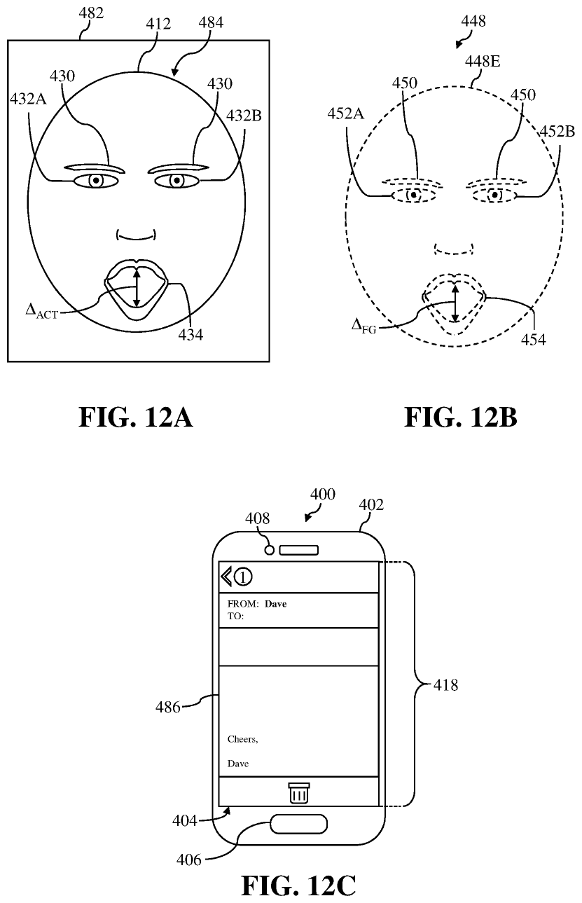

In addition to identifying the plurality of facial features 430-434 of user 412 using camera 408, continuously monitoring facial gesture 428 of user 412 also includes detecting movement of at least one facial feature 430-434 of the plurality of identified facial features of user 412. That is, and in a non-limiting example, camera 408 and computing device 400 continuously monitoring facial gesture 428 of user 412 also are configured to detect movement of at least one of the identified facial features 430-434 of user 412 identified using first facial image 424. The detected movement is specific to each identified facial feature 430-440 of user 412. For example, detecting the movement of facial features 430-434 for user 412 can include, but is not limited to, detecting eyebrow(s) 430 of user 412 raising or lowering (see, FIG. 6A), detecting eye(s) 432A, 432B opening or closing (see, FIG. 9A), detecting mouth 434 of user 412 opening or closing (see, FIG. 12A), detecting tooth 436 of user 412 being exposed or hidden (see, FIG. 13A), detecting a deviation of facial position 438 of user 412 (see, FIG. 14A), and/or detecting tongue 440 of user 412 being exposed or hidden (see, FIG. 15A).

In another non-limiting example, first facial image 424 includes a baseline facial gesture 442 for the plurality of (identified) facial features 430-440. Baseline facial gesture 442 may define and/or establish a “standard,” “normal,” and/or “relaxed” position and/or orientation for the plurality of identified facial features 430-440 for user 412. As shown in FIG. 5, baseline facial gesture 442 included in first facial image 424 may include eyebrows 430 of user 412 relaxed (e.g., not raised), eyes 432A, 432B of user 412 open, and mouth 434 of user 412 substantially or completely closed (e.g., teeth or tongue hidden). In a non-limiting example, baseline facial gesture 442 is established and/or defined based on first facial image 424 captured by camera 408 upon user 412 engaging and/or opening e-mail application 418. That is, baseline facial gesture 442 can be established in real-time once camera 408 becomes engaged to capture and/or obtain first facial image 424. In another non-limiting examples, baseline facial gesture 442 is predetermined or pre-established by user 412. In this example, user 412 can create baseline facial gesture 442 by purposefully taking a photo or video of their own face prior to engaging e-mail application 418. Alternatively, baseline facial gesture 442 can be established after user 412 is prompted and/or instructed to make or create baseline facial gesture 442. Specifically, after user 412 engages e-mail application 418, computing device 400 can provide an additional prompt or notification including instructions (e.g., eyebrows relaxed, eyes open, mouth closed) to user 412 to create, generate, and/or establish baseline facial gesture 442. As discussed herein, baseline facial gesture 442 is utilized to detect movement of the identified facial features 430-440 for user 412 and/or determine if facial features 430-440 of user 412 deviate, move, and/or equals/exceed a facial gesture threshold in order to trigger or execute an action within e-mail application 418.

The plurality of facial features 430-440 for user 412 are identified and movement of facial features 430-440 is detected, for example, using camera 408 of computing device 400, and any suitable system and/or program product stored on and/or accessible by computing device 400 that is configured to analyze images (e.g., photos, videos) of user 412 captured by camera 408. For example, computing device 400 can utilize ARKit, developed by Apple Inc. to identify and detect movement of the plurality of facial features 430-440 of user 412 on computing device 400.

FIGS. 6A-6C show various views of a facial image, predetermined facial image or gesture, and computing device 400 including e-mail application 418, respectively. With reference to each of the figures, processes for performing an action within e-mail application 418 is will be discussed in detail below.

FIG. 6A shows facial image 444 of user 412. Facial image 444 shown in FIG. 6A is taken and/or captured subsequent to and/or after first facial image 424 is captured or obtained by camera 408 of computing device 400. Similar to first facial image 424, facial image 444 includes a facial gesture 446 and identified facial features 430-434 for user 412. With comparison to first facial image 424 shown in FIG. 5A, facial gesture 446 of facial image 444 shown in FIG. 6A differs from and/or is distinct from facial gesture 428 of first facial image 424. More specifically, at least one facial feature 430-434 for user 412 has moved and/or changed position on user's 412 face. As discussed herein, camera 408 continuously monitoring user 412 detects the movement of facial feature(s) 430-434. In the non-limiting example shown in FIG. 6A, it is determined and/or detected that eyebrows 430 of user 412 are raised from their initial position (e.g., first facial image 424).

In response to detecting the movement of eyebrows 430, computing device 400 compares facial gesture 446 including the newly moved eyebrows 430 with a plurality of predetermine facial gestures. FIG. 6B shows one image of a predetermined facial gesture 448A of a plurality of predetermined facial gestures 448. The plurality of predetermined facial gestures 448 are stored on, or alternatively are accessible by, computing device 400 in order to perform the process of executing an action within e-mail application 418, as discussed herein. The images of the plurality of predetermined facial gestures 448 include a predetermined, generated, and/or modelled face of a user that includes facial features 450-460. Facial features 450-460 included in the images of predetermined facial gestures 448 correspond to and/or are similar to facial features 430-440 of user 412 identified in facial images 424, 444. For example, and as shown in FIG. 6B, facial features included, shown, and/or identified in the image of predetermined facial gesture 448A include eyebrows 450, eyes 452A, 452B, and mouth 454. In other non-limiting examples discussed herein, facial features included, shown, and/or identified in the image of predetermined facial gesture 448A include a tooth 456 (see, FIG. 13B), a facial position 458 (see, FIG. 14B), and/or a tongue 460 (see, FIG. 15B). Predetermined facial gestures 448, and more specifically the position, orientation, and/or details of each facial features 450-460 for each predetermined facial gesture 448, are preprogrammed, pre-established, and/or pre-defined based on the movement capabilities of each facial feature 450-460. For example, and as shown in FIG. 6B, predetermined facial gesture 448A are predefined as a gesture that includes raised eyebrows 450, based on a user's eyebrows (e.g., eyebrows 430 of user 412) ability to be raised and/or lowered. Other predetermined facial gestures 448 are predefined based on the movement capabilities of other facial features (e.g., eyes 452A, 452B opening/closing, mouth 454 opening/closing, and the like).

Each of the plurality of predetermined facial gestures 448 are also associated with a corresponding action to be performing in an application of computing device 400. More specifically, in addition to being predefined based on the movement capabilities of facial features 450-460, each predetermined facial gesture 448 is includes a predefined or previously associated action that is performed in an application of computing device 400 in response to computing device 400 and/or camera 408 determining user 412 makes a facial gesture that matches predetermined facial gesture 448. The action associated with each predetermined facial gesture 448 is specific to the application operating on computing device 400. As such, a single predetermined facial gesture 448 can be used to perform a first action in a first application, and a second, distinct action in a second distinct application. In the non-limiting example shown in FIG. 6B, predetermined facial gesture 448A (e.g., raised eyebrows 450) is associated with opening the first e-mail 420A in e-mail application 418 when e-mail application 418 is engaged and/or operating on computing device 400.

Once a change in facial gesture 446 of user 412 is detected, and more specifically movement of at least one facial feature 430-440 of user 412 is detected, computing device 400 compares monitored facial gesture 446 of user 412 with the plurality of predetermined facial gestures 448. Computing device 400 compares facial gesture 446 of user 412 with each of the plurality of predetermined facial gestures 448 to determine if facial gesture 446 of user matches one of the plurality of predetermined facial gestures 448. In a non-limiting example, comparing facial gesture 446 of user 412 with predetermined facial gestures 448 includes determining if a detected movement of facial feature(s) 430-440 of user 412 matches a predetermined movement of a corresponding facial feature(s) 450-460 associated with predetermined facial gestures 448. Computing device 400 determines facial gesture 446 matches one of the plurality of predetermined facial gesture 448, for example, by comparing the two images 446, 448 and confirming that the movement and/or change in position of facial feature(s) 430-440 of user 412 are within a (positional) standard deviation (e.g., 10%) from the movement and/or change in position of the corresponding facial feature(s) 450-460 of predetermined facial gestures 448.

In the non-limiting example shown in FIGS. 6A and 6B, computing device 400 compares facial gesture 446 for user 412 to each of the plurality of predetermined facial gestures 448, and determines that facial gesture 446 for user 412 matches predetermined facial gesture 448A of FIG. 6B. Specifically, computing device 400 determines that facial gesture 446 of user 412 substantially matches (i.e., having one or more properties which equate to within a threshold difference) predetermined facial gesture 448A in response to determining the movement and/or change in position for user's 412 eyebrows 430 matches the movement and/or change in position of eyebrows 450 included in predetermined facial gesture 448A.

In response to determining facial gesture 446 of user 412, as captured in facial image 444, matches predetermined facial gesture 448A, computing device 400 executes the corresponding action associated with matched, predetermined facial gesture 448A within the application. As discussed herein, predetermined facial gesture 448A (e.g., raised eyebrows 450) is associated with opening the first e-mail 420A in e-mail application 418 when e-mail application 418 is engaged and/or operating on computing device 400. As such, and as shown in FIG. 6C, when it is determined that facial gesture 446 of user 412 substantially matches predetermined facial gesture 448A, computing device 400 opens first e-mail 420A (e.g., executed action) of e-mail application 418 and displays first e-mail 420A on touch display 404 of computing device 400. In this non-limiting example, computing device 400 opens first e-mail 420A based solely on user's 412 facial gesture 446 and/or without user 412 having to touch and/or physically contact or otherwise physically engage computing device 400.

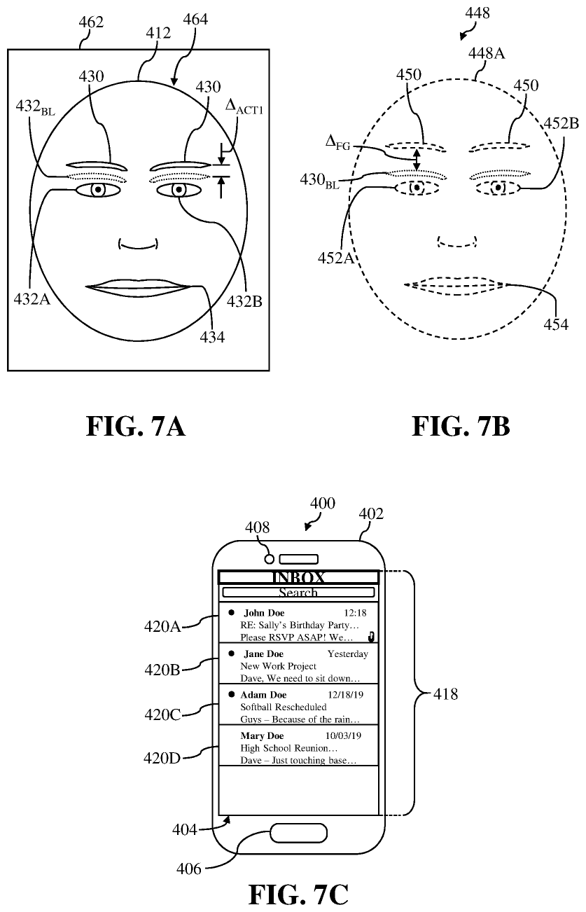

FIG. 7A shows a facial image 462 subsequent to first facial image 424. Similar to facial image 444 of FIG. 6A, facial image 462 shown in FIG. 7A is taken and/or captured subsequent to and/or after first facial image 424 (see, FIG. 5A) is captured or obtained by camera 408 of computing device 400. Also similar to facial image 444, facial image 462 includes facial gesture 464 and identified facial features 430-434 for user 412. With comparison to first facial image 424 shown in FIG. 5A, facial gesture 464 of facial image 462 shown in FIG. 7A differs from and/or is distinct from facial gesture 428 of first facial image 424. In the non-limiting example shown in FIG. 7A, it is determined and/or detected that eyebrows 430 of user 412 are raised from their initial position (e.g., first facial image 424). However, and distinct from facial image 444 including facial gesture 446, eyebrows 430 of user 412 are not raised as high as eyebrows 430 of user 412 as shown in facial gesture 464 (see, FIG. 6A). That is, and as shown in FIG. 7A, user 412 only slightly raises eyebrows 430 in facial gesture 464.

Continuing the Example discussed herein with respect to FIGS. 6A-6C, facial gesture 464 is compared to predetermined facial gestures 448 to determine if facial gesture 464 matches one of the plurality of facial gestures 448. In the non-limiting example shown in FIGS. 7A and 7B, facial gesture 464 (FIG. 7A) is compared to predetermined facial gesture 448A (FIG. 7B) including raised eyebrows 450. As discussed herein, predetermined facial gesture 448A is associated with an action that opens the first e-mail 420A in e-mail application 418 engaged on computing device 400. By comparison, and distinct from the non-limiting example shown and discussed herein with respect to FIGS. 6A-6C, facial gesture 464 does not substantially match predetermined facial gesture 448A. More specifically, computing device 400 determines that facial gesture 464 of user 412 does not match predetermined facial gesture 448A in response to determining the movement and/or change in position for user's 412 eyebrows 430 does not substantially match (e.g., not raised enough) the movement and/or change in position of eyebrows 450 included in predetermined facial gesture 448A. As a result of determining that facial gesture 464 does not match predetermined facial gesture 448A, computing device 400 does not execute the action associated with predetermined facial gesture 448A (e.g., opening first e-mail 420A), and continues to depict the “INBOX” of e-mail application 418.

In another non-limiting example the detected movement of facial feature(s) 430-440 of user 412 is compared to a facial gesture threshold (Δ_{FG}). More specifically, the detected movement of facial feature(s) 430-440 of user 412 is compared to a facial gesture threshold (Δ_{FG}) to determine if the detected movement of facial feature 430-440 equals or exceeds the facial gesture threshold (Δ_{FG}) for the facial feature 430-440. The facial gesture threshold (Δ_{FG}) is based on a predetermined deviation of the facial feature(s) 430-440 from baseline facial gesture 442 of user 412. That is, the facial gesture threshold (Δ_{FG}) is based on a predetermined, predefined, and/or predefined deviation in the position, orientation, and/or details of the detected facial feature 430-440 with reference to and/or in comparison to the position, orientation, and/or details of facial feature 430-440 as defined in baseline facial gesture 442 captured in facial image 424 of user 412 (see, FIG. 5A). Additionally, facial gesture threshold (Δ_{FG}) may be predetermined and/or defined based on the type of facial feature 450-460 which is moving, deviating, and/or changing orientation. For example, facial gesture threshold (Δ_{FG}) for eyes 452A, 452B may be defined as either open or closed, as discussed herein.

In the non-limiting example shown in FIGS. 7A and 7B, the baseline position of eyebrows 430 for user 412, as defined and/or established in baseline facial gesture 442 (see, FIG. 5A), is identified as 430_{BL} (shown in phantom). Additionally, the facial gesture threshold (Δ_{FG}) for triggering the action associated raised eyebrows (e.g., opening first e-mail 420A in e-mail application 418) is indicated by the space between 430_{BL} and eyebrows 450 included in the modelled face of a user that includes facial features 450-460 (e.g., predetermined facial gesture 448). With comparison of FIGS. 7A and 7B, the actual, detected movement or deviation (Δ_{FG}) of eyebrows 430 of user 412 is less than the facial gesture threshold (Δ_{FG}) for eyebrows 450. As a result, computing device 400 does not accept or recognize facial gesture 464 as triggering an action in e-mail application 418.

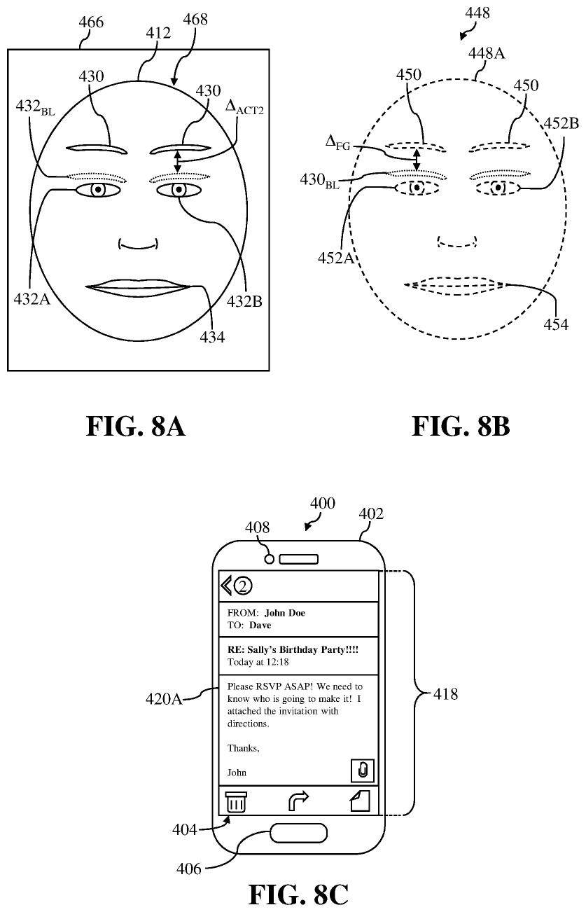

FIG. 8A shows another facial image 466 taken and/or captured subsequent to and/or after first facial image 424 (see, FIG. 5A). Facial image 466 includes facial gesture 468 and identified facial features 430-434 for user 412. As shown in FIG. 8A, and distinct from the non-limiting example shown and discussed herein with respect to FIGS. 7A and 7B, the actual, detected movement or deviation (Δ_{ACT2}) of eyebrows 430 of user 412 in facial gesture 468 is equal to or exceeds facial gesture threshold (Δ_{FG}) for eyebrows 450.

In response to determining the detected movement or deviation (Δ_{ACT2}) of eyebrows 430 of user 412 in facial gesture 468 is equal to or exceeds facial gesture threshold (Δ_{FG}) for eyebrows 450, computing system 400 identifies an action performed in the application of computing device 400 that is associated with the detected movement of facial feature/eyebrows 430 equal to or exceeding facial gesture threshold (Δ_{FG}) for eyebrows 450. Continuing with the examples above, raising eyebrows 430 a distance (Δ_{ACT2}) equal to or exceeding facial gesture threshold (Δ_{FG}) may include an associated action of opening first e-mail 420A in e-mail application 418 operating on computing device 400. As such, once computing device 400 determines that the detected movement or deviation (Δ_{ACT2}) of eyebrows 430 of user 412 in facial gesture 468 is equal to or exceeds facial gesture threshold (Δ_{FG}) for eyebrows 450, computing device 400 may identify the action associated with the movement of eyebrows 430 of user 412 (e.g., opening first e-mail 420A), and execute the action within e-mail application 418. As shown in FIG. 8C, computing device 400 opens first e-mail 420A (e.g., executed action) of e-mail application 418 and displays first e-mail 420A on touch display 404 of computing device 400.

Camera 408 and/or computing device 400 continuously monitors facial gestures of user 412 and/or continues to detect movement of facial features 430-440 of user 412 as user continues to engage e-mail application 418 on computing device 400. That is, computing device 400 continues to perform the processes discussed herein with respect to FIGS. 5A-8C to monitor facial gestures/distinct facial gestures, and/or detect movement of facial features/distinct facial features 430-440 of user 412 to perform or execute additional, subsequent, and/or distinct actions within e-mail application 418. For example, FIG. 9A shows facial image 470 of user 412. Facial image 470 shown in FIG. 9A is taken and/or captured subsequent to and/or after facial image 444 (FIG. 6A) or facial image 466 (FIG. 8A) is captured or obtained by camera 408 of computing device 400. Similar to facial images 444, 466, facial image 470 includes a facial gesture 472 and identified facial features 430-434 for user 412. With comparison to facial image 444 shown in FIG. 6A or facial image 466 shown in FIG. 8A, facial gesture 472 of facial image 470 shown in FIG. 9A differs from and/or is distinct from facial gestures 446, 468. More specifically, at least one distinct facial feature 430-434 for user 412 has moved and/or changed position on user's 412 face with comparison to the moved facial feature 430-440 in facial images 444, 466. More specifically, computing device 400 and/or camera 408 may detect eyebrows 430 of user 412 are lowered and/or back to a baseline position (see, FIG. 5A) and the right eye 432A of user 412 is now closed.

In a non-limiting example, computing device 400 may compare distinct facial gesture 472 including closed right eye 452A with the plurality of predetermined facial gestures 448 to determine if the distinct facial gesture 472 matches one of the predetermined facial gestures 448. In the non-limiting example shown in FIG. 9B, and with continued reference to FIG. 9A, computing device compares and determines that facial gesture 472 matches predetermined facial gesture 448B including closed right eye 452A on the modelled face of the user. In determining facial gesture 472 matches predetermined facial gesture 448B, computing device 400 may than execute the distinct action associated with predetermined facial gesture 448B. In the non-limiting example, predetermined facial gesture 448B (e.g., closed right eye 452A) is associated with moving or opening the next e-mail in e-mail application 418 when e-mail application 418 is engaged and/or operating on computing device 400. As shown in FIG. 9C, when it is determined that facial gesture 472 of user 412 matches predetermined facial gesture 448B, computing device 400 opens second e-mail 420B (e.g., executed action) of e-mail application 418 and displays second e-mail 420A on touch display 404 of computing device 400. In this non-limiting example, computing device 400 opens second e-mail 420B after first e-mail 420A was opened (e.g., first action) based solely on user's facial gesture 446 as discussed herein with respect to FIGS. 6A-6C.

In another non-limiting example, computing device 400 detecting movement and/or a deviation in position, orientation, and/or detail in user's 412 right eye 432A, also determines if the movement of right eye 432A is equal to or exceeds facial gesture threshold (Δ_{FG}) for right eye 452B as shown in on the modelled face of the user (e.g., predetermined facial gesture 448B). As previously defined in baseline facial gesture 442 (FIG. 5A) the baseline position of right eye 432A for user 412 is open. Additionally, the facial gesture threshold (Δ_{FG}) for triggering the action associated movement of right eye 432A is completely closing right eye 452A, as shown in the modelled face of the user, such that no portion of the eye is visible. With comparison of FIGS. 9A and 9B, the actual, detected movement or deviation (Δ_{ACT}) of right eye 432A of user 412 is equal to (e.g., completely closed) the facial gesture threshold (Δ_{FG}) for right eye 452A.

In response to determining the detected movement or deviation (Δ_{ACT}) of right eye 432A of user 412 in facial gesture 472 is equal to or exceeds facial gesture threshold (Δ_{FG}) for right eye 452A, computing system 400 identifies an action performed in the application of computing device 400 that is associated with the detected movement of facial feature/right eye 432A. Continuing with the example above, computing device 400 may identify the distinct action associated with the movement of right eye 432A of user 412 (e.g., opening second e-mail 420B), and execute the distinct action within e-mail application 418. As shown in FIG. 9C, computing device 400 opens second e-mail 420B (e.g., executed, distinct action) of e-mail application 418 and displays second e-mail 420B on touch display 404 of computing device 400.

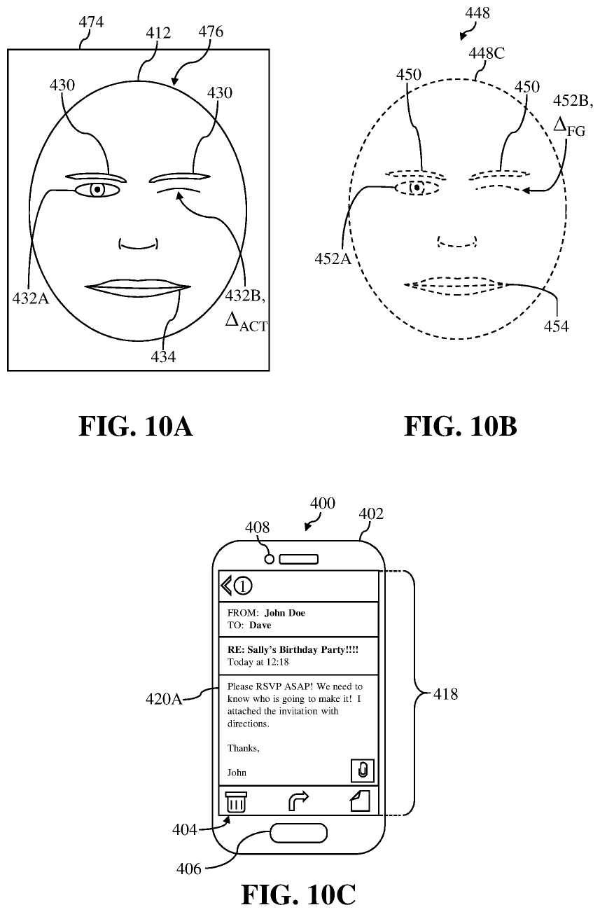

FIGS. 10A-14C show additional non-limiting examples of facial images, predetermined facial gestures including facial features, and computing device 400 executing various associated actions therein. Actions executed in e-mail application 418 on computing device 400, as shown in FIGS. 10C, 11C, 12C, 13C, and 14C may be executed by performing similar processes discussed herein with respect to FIGS. 5A-9AC. It is understood that similarly numbered and/or named components may function in a substantially similar fashion. Redundant explanation of these components has been omitted for clarity.

FIG. 10A shows facial image 474 including facial gesture 476. Facial gesture 476 includes left eye 432B of user 412 closed, while right eye 432A is open. As similarly discussed herein, facial gesture 476 including closed left eye 432B is compared to a plurality of predetermined facial gestures 448 to determine if facial gesture 476 matches one of the predetermined facial gestures. In the non-limiting example, computing device 400 determines that facial gesture 476 matches predetermined facial gesture 448C, which includes closed left eye 452B and opened right eye 452A. In response to determining facial gesture 476 matches predetermined facial gesture 448C, computing device 400 executes the action associated with predetermined facial gesture 448C. In the non-limiting example, predetermined facial gesture 448C (e.g., closed left eye 452B) is associated with opening the previous e-mail, for example, first e-mail 420A, in e-mail application 418 when e-mail application 418 is engaged and/or operating on computing device 400. As shown in FIG. 10C, where computing device 400 previously opened or displayed second e-mail 420B, the performance of facial gesture 476 by user 412, and detection by computing device 400, causes computing device 400 to execute the action of opening the previous e-mail, for example, first e-mail 420A, in e-mail application 418.

In another non-limiting example, computing device 400 detects movement and/or a deviation in position, orientation, and/or detail in user's 412 left eye 432B (and right eye 432A), and determines if the movement of left eye 432B is equal to or exceeds facial gesture threshold (Δ_{FG}) for left eye 452B as shown in on the modelled face of the user (e.g., predetermined facial gesture 448C). With comparison of FIGS. 10A and 10B, the actual, detected movement or deviation (Δ_{ACT}) of left eye 432B of user 412 is equal to (e.g., completely closed) the facial gesture threshold (Δ_{FG}) for left eye 452B.

Computing system 400 may then identify an action performed in the application of computing device 400 that is associated with the detected movement of facial feature/left eye 432B, and execute the action in e-mail application 418. Continuing with the example above, computing device 400 may identify the action associated with the movement of left eye 432B of user 412 (e.g., opening previous e-mail), and execute the action within e-mail application 418. As shown in FIG. 10C, computing device 400 (re)opens first e-mail 420A of e-mail application 418 and displays first e-mail 420A on touch display 404 of computing device 400.

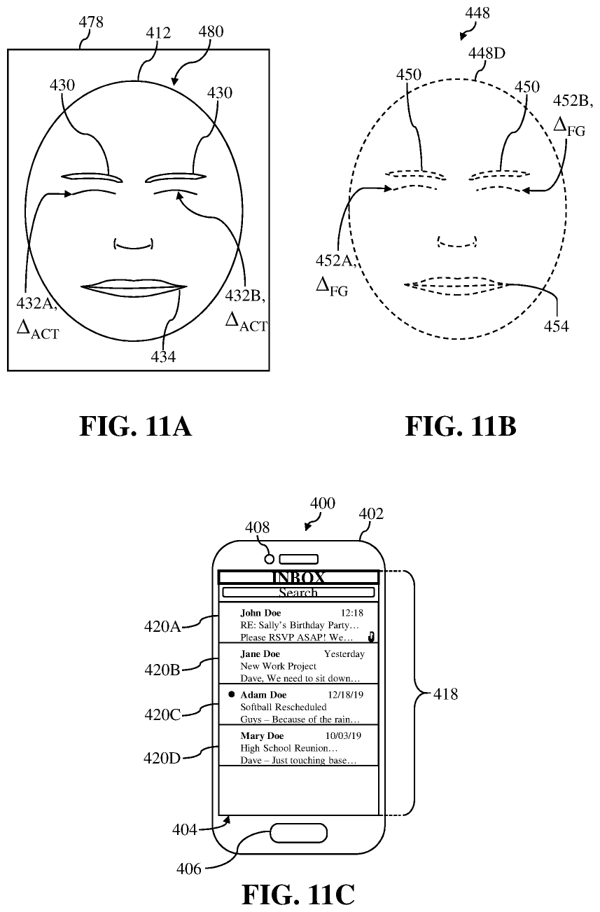

FIG. 11A shows facial image 478 including facial gesture 480. Facial gesture 480 includes both right eye 432A and left eye 432B of user 412 being closed. In response to determining facial gesture 480 matches a predetermined facial gesture 448D (FIG. 11B), computing device 400 may execute an action associated with predetermined facial gesture 448D. In the non-limiting example, predetermined facial gesture 448D (e.g., closed right eye 452A and left eye 452B) is associated with returning to “INBOX” in e-mail application 418, as shown in FIG. 11C. Alternatively, where the detected movement and/or a deviation in position, orientation, and/or detail in user's 412 left eye 432B and right eye 432A (e.g., Δ_{ACT}) is equal to or exceeds facial gesture threshold (Δ_{FG}) for right eye 452A and left eye 452B, respectively, computing system 400 identifies an action performed in the application of computing device 400 that is associated with the detected movement of right eye 432A and left eye 432B. Additionally, computing device 400 then executes the identified action in e-mail application 418, as shown in the non-limiting example of FIG. 11C.

FIG. 12A shows facial image 482 including facial gesture 484. Facial gesture 484 includes mouth 434 of user 412 open and teeth 436 (FIG. 13A) and tongue 440 (FIG. 15) hidden. In response to determining facial gesture 484 matches a predetermined facial gesture 448E (FIG. 12B), computing device 400 may execute an action associated with predetermined facial gesture 448E. In the non-limiting example, predetermined facial gesture 448E (e.g., open moth 434) is associated with opening a new e-mail 486 to send in e-mail application 418, as shown in FIG. 12C. Alternatively, where the detected movement and/or a deviation in position, orientation, and/or detail in user's 412 mouth 434 (e.g., Δ_{ACT}) is equal to or exceeds facial gesture threshold (Δ_{FG}) for mouth 454, computing system 400 identifies an action performed in the application of computing device 400 that is associated with the detected movement of mouth 434. Additionally, computing device 400 then executes the identified action in e-mail application 418, as shown in the non-limiting example of FIG. 12C.

FIG. 13A shows facial image 488 including facial gesture 490. Facial gesture 490 includes mouth 434 of user 412 open and teeth 436 exposed. In response to determining facial gesture 490 matches a predetermined facial gesture 448F (FIG. 13B), computing device 400 may execute an action associated with predetermined facial gesture 448F. In the non-limiting example, predetermined facial gesture 448F (e.g., open mouth 434, exposed teeth 436) is associated with moving a work e-mail (e.g., third e-mail 420C) to a sub-folder (e.g., “Work Folder”) in e-mail application 418, as shown in FIG. 13C. Alternatively, where the detected movement and/or a deviation in position, orientation, and/or detail in user's 412 mouth 434 and exposure of teeth 436 (e.g., Δ_{ACT}) is equal to or exceeds facial gesture threshold (Δ_{FG}) for mouth 454 and teeth 456, computing system 400 identifies an action performed in the application of computing device 400 that is associated with the detected movement of mouth 434 and teeth 436. Additionally, computing device 400 then executes the identified action in e-mail application 418, as shown in the non-limiting example of FIG. 13C.

FIG. 14A shows facial image 492 including facial gesture 494. Facial gesture 494 includes a distinct facial position 438 for user 412. That is, rather than a change in a specific facial feature 430-440 of user 412, facial gesture 494 shown in FIG. 14A includes a change, movement, and deviation in the orientation and/or facial position 438 of user 412. In the non-limiting example, user 412 is tilting their head back and/or up, such that camera 408 and/or computing device 400 does not detect user's 412 eyes 432A, 432B.

As similarly discussed herein, in response to determining facial gesture 494 matches a predetermined facial gesture 448G (FIG. 14B), computing device 400 may execute an action associated with predetermined facial gesture 448G. In the non-limiting example, predetermined facial gesture 448G (e.g., deviated/tilted up facial position 438) is associated with scrolling through, and specifically scrolling up, e-mails 420A-420D in e-mail application 418. As shown in FIG. 14C, after detecting the change in facial position 438, computing device 400 scrolls up through e-mails in e-mail application 418 such that only the fourth e-mail 420D is visible—e-mails 420A-420C are scrolled out of view on touch display 404. Alternatively, where the detected movement and/or a deviation in position, orientation, and/or detail in user's facial position 438 (e.g., Δ_{ACT}) is equal to or exceeds facial gesture threshold (Δ_{FG}) for facial position 458, computing system 400 identifies an action performed in the application of computing device 400 that is associated with the detected movement of facial position 438. Additionally, computing device 400 then executes the identified action in e-mail application 418, as shown in the non-limiting example of FIG. 14C.

Although discussed herein as identifying and/or detecting a single movement, and/or movement of a single facial feature 430-440, computing device 400 can also perform actions within an application after detecting and/or identifying a sequence of facial gestures and/or sequential movements in facial features of user 412. Turning to FIGS. 15A-15C, a non-limiting example of performing actions in an application computing device 400 using sequential facial gestures and/or sequential movements in facial features is discussed. It is understood that similarly numbered and/or named components may function in a substantially similar fashion. Redundant explanation of these components has been omitted for clarity.

FIG. 15A shows facial images 496A, 496B including facial gesture 498A, 498B, respectively. Facial image 496A is taken prior to facial image 496B. Facial gesture 498A of facial image 496A includes tongue 440 of user 412 exposed. As shown in facial image 496B of FIG. 15A, facial image 496B includes tongue 440 exposed, as well as right eye 432A closed. In a non-limiting example, exposing, identifying, and/or detecting user's 412 tongue 440 does not include an associated action in e-mail application 418, and thus on its own, does not cause computing device 400 to execute an action in e-mail application 418. However, exposing user's tongue 440 does cause computing device 400 to continuously monitor and/or detect a plurality of sequential facial gestures 498A, 498B and/or movements of facial features (e.g., tongue 440, right eye 432A) for user 412.

In a non-limiting example, the sequence of facial gestures 498A, 498B including exposed tongue 440 (facial gesture 498A) followed by closing right eye 432A (facial gesture 498B) is compared to a plurality of sequential predetermined facial gestures 448 to determine if sequential facial gestures 498A, 498B match one of the sequential predetermined facial gestures. In the non-limiting example, computing device 400 determines that sequential facial gestures 498A, 498B matches sequential, predetermined facial gestures 448H-1, 448H-2, which includes exposed tongue 460 (facial gesture 448H-1) and closed right eye 452A (facial gesture 448H-2). As similarly discussed herein, in response to determining sequential facial gestures 498A, 498B matches sequential, predetermined facial gestures 448H-1, 448H-2, computing device 400 executes the action associated with sequential, predetermined facial gestures 448H-1, 448H-2. In the non-limiting example, sequential, predetermined facial gestures 448H-1, 448H-2 (e.g., exposed tongue 460 followed by closed right eye 452A) is associated with selected and deleting all e-mails 420A-420D in e-mail application 418. As shown in FIG. 15C, after computing device 400 determines sequential facial gestures 498A, 498B matches sequential, predetermined facial gestures 448H-1, 448H-2, computing device 400 selects and deletes all existing e-mails 420A-420D (see, FIG. 4) in e-mail application 418.

In another non-limiting example, computing device 400 first detects movement and/or a deviation in position, orientation, and/or detail in user's 412 tongue 440 (Δ_{ACT1}), and determines if the movement of tongue 440 is equal to or exceeds facial gesture threshold (Δ_{FG1}) for tongue 460 as shown in on the modelled face of the user (e.g., predetermined facial gesture 448H-1). In the non-limiting example shown in FIGS. 15A and 15B, the actual, detected movement or deviation (Δ_{ACT1}) of tongue 440 of user 412 is equal to or greater than (e.g., exposed) the facial gesture threshold (Δ_{FG1}) for tongue 460. As a result, and knowing that exposure or detection of tongue 440 triggers a determination and/or monitoring of sequential movements, computing device 400 then detects movement and/or a deviation in position, orientation, and/or detail in user's 412 right eye 432A (Δ_{ACT2}). Computing device 400 then determines if the movement of right eye 432A is equal to or exceeds facial gesture threshold (Δ_{FG2}) for right eye 452A as shown in on the modelled face of the user (e.g., predetermined facial gesture 448H-2), while tongue 440 remains exposed. In the non-limiting example shown in FIGS. 15A and 15B, the actual, detected movement or deviation (Δ_{ACT2}) of right eye 432A of user 412 is equal to (e.g., completely closed) the facial gesture threshold (Δ_{FG2}) for right eye 452A. Additionally, tongue 440 remains exposed while the actual, detected movement or deviation (Δ_{ACT2}) of right eye 432A of user 412 is equal to (e.g., completely closed) the facial gesture threshold (Δ_{FG2}) for right eye 452A.

Computing system 400 may then identify an action performed in the application of computing device 400 that is associated with the detected sequential movement of user's 412 tongue 440 then right eye 432A. Continuing with the example above, computing device 400 may identify the action associated with the sequential movement of user's 412 tongue 440 then right eye 432A, and execute the action within e-mail application 418, e.g., selects and deletes all e-mails 420A-420D in e-mail application 418, as shown in FIG. 15C.

Although discussed herein as being implemented in an e-mail application, it is understood that the processes of performing an action in an application operating on a computing device can included any application that requires a user to interact and/or provide input for functionality of the Application. Additionally, although shown herein as being a handheld computing device (e.g., smart phone), it is understood that processes of performing the action in the application can be performed using any computing device that includes a camera included therein.

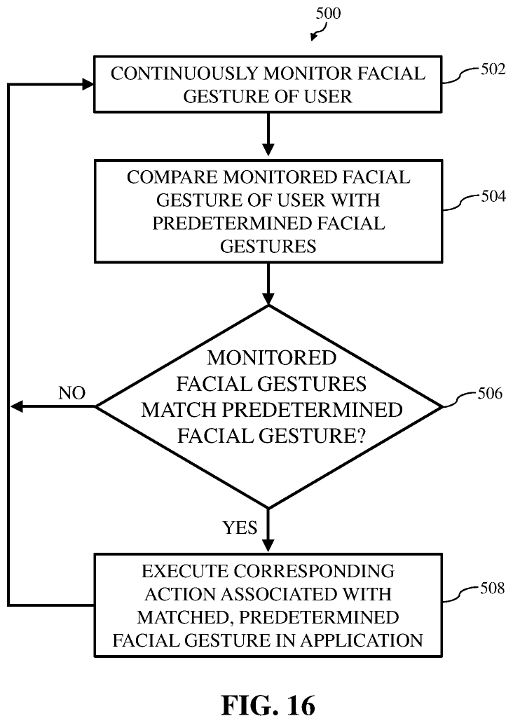

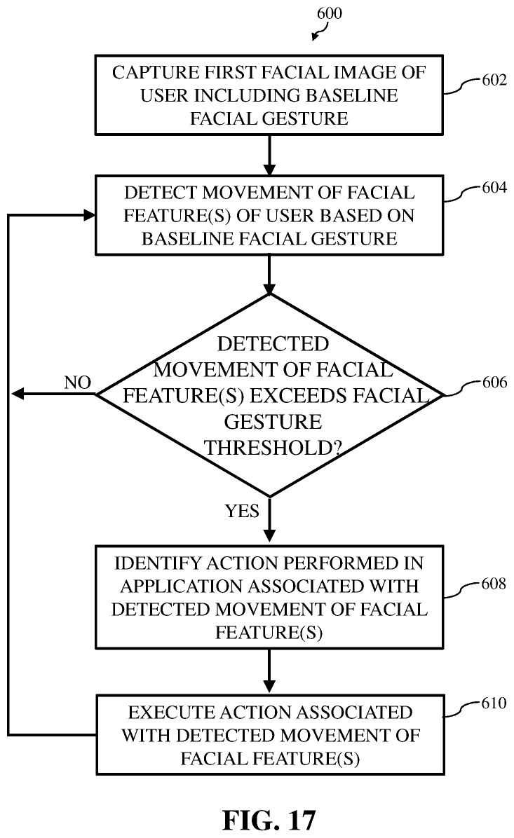

FIGS. 16 and 17 show example processes 500, 600 for performing actions in an application of a computing device. More specifically, FIGS. 16 and 17 show flow diagrams illustrating non-limiting example processes for performing actions in an application of a computing device based solely on facial gestures and/or the movement of facial features for a user of the computing device.

In process 502, as shown in FIG. 16, facial gestures of a user are monitored. More specifically, facial gestures of a user are continuously monitored using a camera in communication with and/or included in a computing device. The facial gestures of the user are continuous monitored in response to the user engaging an application on the computing device. In a non-limiting example, the facial gestures of the user are continuous monitored by automatically engaging the camera of the computing device. That is, the camera in communication with the computing device is automatically engaged in response to the user engaging the application on the computing device. Alternatively, a user can be prompted to engage the camera in communication with the computing device after engaging the application on the computing device, in order to continuously monitor the facial gestures of the user.

Additionally, continuously monitoring the facial gestures of the user, as in process 502, can also include identifying a plurality of facial features of the user via the camera in communication with the computing device, and detecting movement of at least one facial feature of the plurality of facial features of the user via the camera. The plurality of identified facial features of the user can include at least one of an eyebrow of the user, an eye of the user, a mouth of the user, a tooth of the user, a tongue of the user, or a facial position of the user. In a non-limiting example, detecting movement of the at least one facial feature of the plurality of facial features of the user includes one of detecting the eyebrow of the user raising or lowering, detecting the eye of the user opening or closing, detecting the mouth of the user opening or closing, detecting the tooth of the user being exposed or hidden, detecting the tongue of the user being exposed or hidden, and/or detecting a deviation of the facial position of the user.

In process 504, the monitored facial gestures of the user are compared with a plurality of predetermined facial gestures. Each of the plurality of predetermined facial gestures are associated with a corresponding action to be performed in the application of the computing device. Comparing the monitored facial gesture of the user with the plurality of predetermined facial gestures also include determining if the detected movement of the at least one facial feature of the plurality of identified facial features of the user matches a predetermined movement of a facial feature associated with the predetermined facial gesture of the plurality of predetermined facial gestures.

In process 506, it is determined if the monitored facial gesture matches one of the plurality of predetermined facial gestures. That is, in comparing the monitored facial gestures with the plurality of predetermined facial gestures, it is determined if the monitored facial gesture matches one of the plurality of predetermined facial gestures. In response to determining that the monitored facial gesture does not match one of the plurality of predetermined facial gestures (“NO” at process 506), process 502 is performed again. Alternatively where it is determining that the monitored facial gesture does match one of the plurality of predetermined facial gestures (“YES” at process 506), process 508 is performed.

In process 508, a corresponding action associated with the matched, predetermined facial gesture is executed in the application. That is, in response to determining the monitored facial gesture of the user matches one of the plurality of predetermined facial gestures (“YES” at process 506), the action associated with the matched predetermined facial gesture is performed and/or executed in the application operating on the computing device. After the action is executed in the Application, processes 502-508 are performed again with respect to the monitoring and/or detection of a distinct facial gesture made by the user of the computing device.

Although discussed herein as monitoring a single facial gesture, it is understood that processes 502-508 can be performed by monitoring a sequence of facial gestures in order to preform and/or execute an action within the application operating on the electronic device. In this non-limiting example, process 502 can include detecting a plurality of sequential movements of at least one of the at least one facial feature of the plurality of facial features for the user, or at least one distinct facial feature of the plurality of facial features of the user. Additionally, in the non-limiting example, processes 504 and 506 can include determining if the plurality of sequential movements matches a predetermined sequence of movements of the facial features associated with one of the plurality of predetermined facial gestures.

Turning to FIG. 17, in process 602 a first facial image of the user is captured. The first facial image of the user is captured using a camera included in and/or in communication with the computing device including the application. The first facial image of the user is captured in response to the user engaging the application on the computing device. The first facial image includes a baseline facial gesture for a plurality of facial features for the user. In a non-limiting example, the first facial image of the user is captured after automatically engaging the camera of the computing device. That is, the camera in communication with the computing device is automatically engaged to capture the first facial image of the user in response to the user engaging the application on the computing device. Alternatively, a user can be prompted to engage the camera in communication with the computing device after engaging the application on the computing device, in order to capture the first facial image.

Additionally, capturing the first facial image of the user, as in process 602, can also include identifying a plurality of facial features of the user via the camera in communication with the computing device. The plurality of identified facial features of the user can include at least one of an eyebrow of the user, an eye of the user, a mouth of the user, a tooth of the user, a tongue of the user, or a facial position of the user.

In process 604, movement of at least one facial feature of the plurality of facial features of the user is detected. The movement of the facial feature(s) is detected via the camera in communication with the computing device. Movement is detected based on the baseline facial gesture included in the captured, first facial image. Specifically, the baseline facial gesture includes a standard position or orientation for each of the identified facial features of the user. Movement of the facial feature(s) is detected when one or more the identified facial features moves, changes position, and/or changes orientation from the standard position or orientation as defined by the baseline facial gesture. In a non-limiting example, detecting movement of the at least one facial feature of the plurality of facial features of the user includes one of detecting the eyebrow of the user raising or lowering, detecting the eye of the user opening or closing, detecting the mouth of the user opening or closing, detecting the tooth of the user being exposed or hidden, detecting the tongue of the user being exposed or hidden, and/or detecting a deviation of the facial position of the user.

In process 606, it is determined if the detected movement of the at least one facial feature of the plurality of facial features of the user is equal to or exceeds a facial gesture threshold. That is, the detected movement of the facial feature(s) is compared to a corresponding facial gesture threshold specific to the facial feature(s) that movement is detected, and it is determined if the movement of the facial feature(s) is equal to or exceeds the corresponding facial gesture threshold. The facial gesture threshold for each facial feature is based on the facial feature itself, its movement and/or orientation capabilities, and a predetermined deviation of the facial feature from the baseline facial gesture of the user. Specifically, the facial gesture threshold is determined, at least in part, by a deviation for the position and/or orientation defined in the baseline facial gesture included in the captured, first facial image of the user. In response to determining that the movement of the facial feature does not exceed the facial gesture threshold (“NO” at process 606), process 602 is performed again. Alternatively where it is determining that the movement of the facial feature does equal or exceeds the facial gesture threshold (“YES” at process 606), process 608 is performed.

In process 608 an action to be performed in the application of the computing device is identified. Specifically, the action associated with the detected movement of the at least one facial feature equal to or exceeding the facial gesture threshold is identified.

In process 610 the identified action of process 608 is executed. That is, the identified action associated with the detected movement of the at least one facial feature equal to or exceeding the facial gesture threshold is triggered, performed, and/or executed in the application operating on the computing device. After the action is executed in the Application, processes 604-610 are performed again with respect to the detection of movement of a (distinct) facial feature for the user.

Similar to process 500, although discussed herein as detecting movement of a single facial feature, it is understood that processes 602-610 can be performed by monitoring a sequence of movements for one or more facial features in order to preform and/or execute an action within the application operating on the electronic device. In this non-limiting example, process 604 can include detecting a plurality of sequential movements of at least one of the at least one facial feature of the plurality of facial features for the user, or at least one distinct facial feature of the plurality of facial features of the user. Additionally, in the non-limiting example, process 606 can include determining if the plurality of sequential movements equal or exceed facial gesture thresholds for a sequence of movements of the facial features.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

As discussed herein, various systems and components are described as “obtaining” data. It is understood that the corresponding data can be obtained using any solution. For example, the corresponding system/component can generate and/or be used to generate the data, retrieve the data from one or more data stores (e.g., a database), receive the data from another system/component, and/or the like. When the data is not generated by the particular system/component, it is understood that another system/component can be implemented apart from the system/component shown, which generates the data and provides it to the system/component and/or stores the data for access by the system/component.

The foregoing drawings show some of the processing associated according to several embodiments of this disclosure. In this regard, each drawing or block within a flow diagram of the drawings represents a process associated with embodiments of the method described. It should also be noted that in some alternative implementations, the acts noted in the drawings or blocks may occur out of the order noted in the figure or, for example, may in fact be executed substantially concurrently or in the reverse order, depending upon the act involved. Also, one of ordinary skill in the art will recognize that additional blocks that describe the processing may be added.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise. “Approximately” as applied to a particular value of a range applies to both values, and unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

1. A method of performing e-mail actions in an e-mail application of a computing device, the method comprising:
continuously monitoring a facial gesture of a user, via a camera in communication with the computing device, in response to the user engaging the e-mail application on the computing device, the monitoring including:
detecting a trigger facial gesture of the user, and
in response to detecting the trigger facial feature of the user, detecting a sequence of a plurality of facial gestures of the user;
comparing the detected sequence of the plurality of facial gestures with a plurality of predetermined sequences of facial gestures, each of the plurality of predetermined sequences of facial gestures are associated with a different corresponding e-mail action performed in the e-mail application of the computing device; and
in response to determining the detected sequence of the plurality of facial gestures matches one of the plurality of predetermined sequences of facial gestures, executing the corresponding e-mail action associated with the matched, predetermined sequence of facial gestures in the e-mail application.

2. The method of claim 1, further comprising one of:
automatically engaging the camera in communication with the computing device in response to the user engaging the e-mail application on the computing device, or
prompting the user to engage the camera in communication with the computing device after the user engages the e-mail application on the computing device.

3. The method of claim 1, wherein continuously monitoring the facial gesture of the user includes, for each facial gesture of the user:
identifying a plurality of facial features of the user via the camera in communication with the computing device; and
detecting movement of at least one facial feature of the plurality of facial features of the user via the camera in communication with the computing device.

4. (canceled)

5. (canceled)

6. (canceled)

7. The method of claim 3, wherein the plurality of identified facial features of the user includes at least one of:
an eyebrow of the user, an eye of the user, a mouth of the user, a tooth of the user, a tongue of the user, or a facial position of the user.

8. The method of claim 7, wherein detecting movement of the at least one facial feature of the plurality of facial features of the user includes at least one of:
detecting the eyebrow of the user raising or lowering,
detecting the eye of the user opening or closing,
detecting the mouth of the user opening or closing,
detecting the tooth of the user being exposed or hidden,
detecting the tongue of the user being exposed or hidden, or
detecting a deviation of the facial position of the user.

9. (canceled)

10. A computing device comprising:
a camera;
at least one processor; and
memory storing computer-executable instructions that, when executed by the at least one processor, cause the computing device to:
capture a first facial image of a user, using the camera, in response to the user engaging an e-mail application on the computing device, the first facial image including a baseline facial gesture for a plurality of facial features for the user;
detect a trigger facial gesture of the user;
in response to detecting the trigger facial feature of the user, detect a sequence of a plurality of facial gestures of the user, and for each facial gesture in the detected sequence of the plurality of facial gestures of the user:
detect movement of at least one facial feature of the plurality of facial features of the user engaging the e-mail application on the computing device; and
determine if the detected movement of the at least one facial feature of the plurality of facial features of the user exceeds a facial gesture threshold, the facial gesture threshold based on a predetermined deviation of the at least one facial feature from the baseline facial gesture for the user;
in response to determining the detected movement of the at least one facial feature of the plurality of facial features of the user exceeds the facial gesture threshold for each facial gesture in the detected sequence of the plurality of facial gestures of the user, identify an e-mail action performed in the e-mail application of the computing device that is associated with the detected sequence of the plurality of facial gestures of the user, wherein each of the plurality of predetermined sequences of facial gestures are associated with a different assoiciated e-mail action performed in the e-mail application; and
execute the identified e-mail action associated with the detected sequence of the plurality of facial gestures of the user.

11. The computing device of claim 10, wherein the computer-executable instructions as executed by the at least one processor, further cause the computing device to at least one of:
automatically engage the camera in response to the user engaging the e-mail application on the computing device, or
prompt the user to engage the camera after the user engages the e-mail application on the computing device.

12. (canceled)

13. The computing device of claim 10, wherein the computer-executable instructions as executed by the at least one processor that captures the first facial image of the user further causes the computing device to:
identify at least one of: an eyebrow of the user, an eye of the user, a mouth of the user, a tooth of the user, a tongue of the user, or a facial position of the user.

14. The computing device of claim 10, wherein the computer-executable instructions as executed by the at least one processor that detects movement of the at least one facial feature of the plurality of facial features of the user further cause the computing device to:
detect the eyebrow of the user raising or lowering,
detect the eye of the user opening or closing,
detect the mouth of the user opening or closing,
detect the tooth of the user being exposed or hidden,
detect the tongue of the user being exposed or hidden, or
detect a deviation of the facial position of the user.

15. (canceled)

16. A computer program product stored on a non-transitory computer readable storage medium, which when executed by a computing device including a camera, performs e-mail actions in an e-mail application of the computing device, wherein the computer program product comprises:
program code that instructs the camera to capture a first facial image of a user in response to the user engaging the e-mail application on the computing device, the first facial image including a baseline facial gesture for a plurality of facial features for the user;
program code that detects a trigger facial gesture of the user, and in response to detecting the trigger facial feature of the user, detect a sequence of a plurality of facial gestures of the user, and for each facial gesture in the detected sequence of the plurality of facial gestures of the user:
instructs the camera to detect movement of at least one facial feature of the plurality of facial features of the user engaging the e-mail application on the computing device; and
determines if the detected movement of the at least one facial feature of the plurality of facial features of the user exceeds a facial gesture threshold, the facial gesture threshold based on a predetermined deviation of the at least one facial feature from the baseline facial gesture for the user;
program code that, in response to determining the detected movement of the at least one facial feature of the plurality of facial features of the user exceeds the facial gesture threshold for each facial gesture in the detected sequence of the plurality of facial gestures of the user, identifies an e-mail action performed in the e-mail application of the computing device that is associated with the detected sequence of the plurality of facial gestures of the user, wherein each of the plurality of predetermined sequences of facial gestures are associated with a different associated e-mail action performed in the e-mail application; and
program code that executes the identified e-mail action associated with the detected sequence of the plurality of facial gestures of the user.

17. The computer program product of claim 16, further comprising at least one of:
program code that automatically engages the camera in response to the user engaging the e-mail application on the computing device, or
program code that prompts the user to engage the camera after the user engages the e-mail application on the computing device.

18. (canceled)

19. (canceled)

20. The computer program product of claim 16, further comprising:
program code that identifies at least one of: an eyebrow of the user, an eye of the user, a mouth of the user, a tooth of the user, a tongue of the user, or a facial position of the user using the captured first facial image.
